(19) United States
(12) Patent Application Publication
(10) Pub. No.: US 2008/0208622 A1
(43) Pub. Date: Aug. 28, 2008

(54) METHOD OF DELIVERY OF CARE FOR ASSISTED LIVING FACILITIES

(76) Inventors: John Fullerton, Fairfax, CA (US); Kate McElroy Fullerton, Fairfax, CA (US)

Correspondence Address: DAVIS WRIGHT TREMAINE LLP/Los Angeles, 865 FIGUEROA STREET, SUITE 2400, LOS ANGELES, CA, 90017-2566, US

(21) Appl. No.: 11/680,155

(22) Filed: Feb. 28, 2007

(51) Int. Cl. G06Q 50/00

(52) U.S. Cl. 705/2

(57) ABSTRACT

The present invention relates to methods and tools for the delivery and administration of care to residents of an assisted living facility. The health of elderly residents almost always declines after moving to an assisted living facility, and up until now, a high level of medical care and the integration of care with multiple caregivers was not provided to the residents. Care administered according to the method of the invention is cohesive and comprehensive, and includes a high level of medical care for acutely ill residents. In one aspect of the invention, the method defines components for the delivery of care and their organization. In another aspect of the invention, the method and its related protocols and procedures is implemented in a kit for dissemination to all facilities offering residential care or assisted living services to achieve efficient delivery and administration of care to residents. In yet another aspect of the invention the method is integrated into a system capable of adoption by residential care or assisted living facilities to achieve streamlined, efficient delivery of care to its residents.

### FIELD OF INVENTION

The invention relates to methods of delivery of care, specifically, to the organization and administration of care across multiple disciplines for streamlined assistance of residents along the continuum of geriatric care in an assisted living setting. These methods of delivery of care utilize kits and a system for assistance in the administration of the methods. The methods of delivery of care also include provisions for assisted living dementia and assisted living palliative care units.

### BACKGROUND OF THE INVENTION

Aged individuals who are in relatively good health and no longer capable of living on their own have found refuge in assisted living/residential care facilities. These facilities provide residential settings with living amenities intended to facilitate a semi-independent lifestyle for the elderly. While the services provided by these facilities vary, many provide laundry, food, and cleaning services in addition to some low level medical care. Individuals benefit from these organized residential settings; however, in almost all cases, residents experience a decline in health due to the natural progression of aging. Currently, residents who are in ill-health are almost always transferred to other facilities such as skilled nursing facilities, nursing homes, and hospitals. The transfer can be temporary or permanent and may depend upon the health of the resident in addition to their ability to pay for treatment. Oftentimes, elderly residents are shuttled between facilities. The transfer and constant shifting is very disorienting for the transferees and it often further complicates health issues. The shifting is also detrimental to care in that it abrogates any streamlined therapy; for example, medication administration may be confused, diagnoses can be lost, and health setbacks are almost always the result.

Further complicating the issue is the payment associated with care. Insurance coverage is generally only available to patients in skilled nursing facilities, nursing homes, and hospitals. The administration of care to residents in a traditional assisted living or residential care facility is generally not covered by healthcare insurance (including long-term care insurance) and does not qualify as a medical writeoff for tax purposes. Traditional assisted living models up until now have been considered a third party “carve out” by the insurance industry and the U.S. government; therefore, residents, their families, and their estates have had no other options except to pay all associated costs themselves. It is possible that under traditional assisted living and residential facility models, third party payors do not provide assisted living coverage and medical tax relief for residents, families, and their estates because residents who develop complex medical problems, experience functional decline, suffer significant dementia, or confront end-of-life issues cannot be adequately cared for. As a result, the ability of the residents and their families to privately pay has been the predominant mechanism for assisted living facilities to receive revenue. Accordingly, there is a need for the delivery of augmented assisted living care and the creation of a new niche of improved care to facilitate entrance of the third party payor industry into assisted living and residential care arenas.

Up until now, transfer is generally required for residents experiencing health issues, even if staying in a residential care facility would be better for the resident. Assisted living facilities lack adequate medical care or treatment services that are comprehensive and cohesive between different caregivers and staff. The lack of comprehensive treatment is evidenced by, among other things, the lack of available care around the clock, 24 hours a day, 7 days a week, and unavailable care by on-site physician health care workers, nurses, or medical specialists. Some facilities have no medical staff on-site, while others have medical care staff available for a few hours a day. The lack of cohesiveness is evidenced in many situations, for example, where a primary care physician or an on-site medical caregiver is not aware of the medications prescribed to the resident by a cardiologist, urologist, psychologist, or other specialist.

The residential care setting is generally beneficial to the aged; however, there remains a disconnect in the scope of services provided and the facilitation of care. These shortcomings are detrimental to the health of residents, thereby complicating the benefits intended by residential care.

There remain several obstacles to providing an organized, cohesive, and comprehensive environment for living that enhances, not hinders, the unavoidable declining health of residents. For example, there exists a need to bridge the gap between traditional assisted living or residential care and the more highly regulated skilled nursing facilities and nursing home care. Many assisted living and residential care facilities lack the ability to handle more medically complex patients resulting in a transfer to alternate facilities and the inevitable disorientation of the individuals and fragmentation of their care. Oftentimes, transfer uproots a resident's family unit. Moreover, traditional assisted living facilities lack the ability to care for many of these aging patients with the “graying of America” demographically as they develop dementia and require complex care in locked wards. As frail residents inevitably decline over time, traditional assisted living facilities are not medically equipped to provide seamless, on-site palliative and end-of-life hospice care. Thus, there is a need for assisted living and residential care facilities to maintain medical centers on-site or closely related to the facility that are staffed with medical doctors and mid-level practitioners such as nurse practitioners and physician's assistants, as well as medical students, physician's assistant students, and/or nurse practitioner students, in order to deliver care along the geriatric health continuum. There is a further need for staff of the medical center to work closely with many other individuals in the delivery of care, including primary care house staff employed by the facility.

Oftentimes, residents need specialized services that are not provided by a general practitioner, for example, services of specialists such as cardiologists, urologists, psychologists, dentists, podiatrists, ophthalmologists, and physical therapists. Residents also need services of ombudspersons to assist with insurance issues, wound care nurses to assist with wound-related nursing care, activities directors to provide entertainment and mental stimulation, and chaplains to fulfill spiritual needs. The numerous disciplines interacting with the elderly residents are often unaware of the attention or care provided by other caregivers at the facility and/or caregivers in the community. An overlap of care, a lapse of care, or conflicting care can be extremely detrimental to the health and well-being of the elderly residents. Accordingly, there is a further need to organize the many practitioners and staff that come in contact with residents with the core unit of caregivers in the facility, that is, an on-site medical doctor who may also be an on-site medical director and/or on-site mid-level practitioners such as physician's assistants and nurse practitioners. There is an additional need to deliver care to elderly residents in an assisted living facility whereby the care administered is covered by insurance.

In addition to this organization of care, the certification of on-site caregivers and staff is crucial to the quality of care. While it is beneficial to have many individuals involved with the residents, it is crucial for these individuals to be properly licensed and/or certified to do their jobs. Accordingly, there is a need to ensure that all parties have the proper certifications.

With several individuals contributing to the overall care of a resident, there exists a need for these individuals to be aware of and to follow specific protocols and procedures for delivery of care. These protocols and procedures may include how to address the resident; the extent of the service to be rendered; and how to create, store, and maintain records concerning the resident to ensure one cohesive set of resident records and to ensure compliance with applicable laws. Accordingly, there is a need to integrate protocols and procedures within the framework of a comprehensive and cohesive care unit.

Therefore, there remains a significant need in the art for improved methods and tools for the delivery and administration of care in an assisted living or residential care setting.

### SUMMARY OF THE INVENTION

The present invention relates to a methods and tools for the delivery and administration of cohesive and comprehensive care. In one embodiment the delivery of care is for residents of an assisted living facility along the continuum of geriatric care. In another embodiment, the method defines components for the delivery of care and their organization. Components for care may include caregivers in multiple disciplines having unique relationships with one another and with the residents, and further includes a medical center, and dementia and palliative care units within, on the premises of, or near the assisted care facility. In another embodiment, the method and its related protocols and procedures is implemented in a kit for dissemination to all facilities offering residential care or assisted living services to achieve streamlined, efficient delivery and administration of care to its aging residents. In yet another embodiment, the kit includes certification and licensing requirements for caregivers and a method of tracking these requirements. In another embodiment, the method is integrated into a system capable of adoption by residential care or assisted living facilities to achieve streamlined, efficient delivery and administration of care to its aging residents.

### DETAILED DESCRIPTION OF THE INVENTION

Unless defined otherwise, the terms used herein have the same meaning as commonly understood by one of ordinary skill in the art to which this invention belongs. One skilled in the art will recognize many methods, kits, procedures, protocols and systems similar or equivalent to those described herein, which could be used in the practice of the present invention. Indeed, the present invention is in no way limited to the methods, kits, procedures, protocols and systems described. For purposes of the present invention, the following terms are defined below.

“Assisted living facility,” “residential care facility,” and “assisted living residential care facility,” are used interchangeably and generally refer to those facilities providing a residential unit and services to the elderly. These facilities may also include “assisted living dementia units,” and “assisted living hospice and palliative care units.” A third party assisted living facility or a residential care facility means a facility at an alternate location or one run by a different entity.

“Medical center” is a central medical unit or hub for residents to receive a high level of medical care. The medical center is preferably located on-site or close to the residential care facility. It may be located in a separate office within the facility, may be a roving unit that attends to residents wherever they are located, or may be located in a separate office close to the facility, preferably within walking distance and/or within 100 yards of the facility. Location notwithstanding, the medical center may be operated as a separate legal entity from the assisted living facility.

“Medical center staff” is one or more individual making up the medical center that is a central medical unit or hub for delivering the high level of medical care to residents. The medical center staff is preferably comprised of at least one physician who may also be a certified medical director and one or more nurse practitioner or physician's assistant.

“Facility caregiver” is an individual employed by the facility or an individual who has a relationship with the facility as an independent contractor who interacts with the residents.

“Third party caregiver” is an individual not employed by the facility or under a contractual relationship with the facility who interacts with the residents.

“Physician medical director” is preferably a member of the medical center staff and may see residents for medical treatment. The physician medical director may also be employed by the assisted living facility or may be in a contractual arrangement with the assisted living facility, and may serve as an administrative and community liaison for the facility. The physician medical director is certified as a medical doctor and preferably as a medical director.

“Corporate medical director” is preferably a facility caregiver, and may function as a top level medical director focusing on administration of one or more assisted living facility, preferably serving at a regional administrative level, to ensure that medical directors at multiple assisted living facilities are addressing administrative issues consistently and to further ensure that the medical directors are focusing care and compliance with professional standards and industry norms. The corporate medical director is preferably a certified medical director.

“Medical student” is an individual currently studying to become a medical doctor and may be a member of the medical center staff.

“Nurse practitioner” is preferably a member of the medical center staff. The nurse practitioner may also be employed by the assisted living facility or may be in a contractual arrangement with the assisted living facility. The nurse practitioner provides mid-level practitioner support for the residents and serves as a liaison to the nurses serving at the residential care facility.

“Corporate nurse practitioner” is preferably a facility caregiver, and may function as a top level nurse practitioner focusing on administration of nurse practitioners offering services at one or more assisted living facility, preferably serving at a regional administrative level, to ensure that nurse practitioners at multiple assisted living facilities are addressing administrative issues consistently and to further ensure that the nurse practitioners are focusing care and compliance with professional standards and industry norms.

“Nurse practitioner student” is an individual currently studying to become a nurse practitioner and may be a member of the medical center staff.

“Physicians assistant” is preferably a member of the medical center staff. The physician's assistant may also be employed by the assisted living facility or may be in a contractual arrangement with the assisted living facility. The physician's assistant provides mid-level practitioner support for the residents and serves as a liaison to the nurses serving at the residential care facility.

“Corporate physicians assistant” is a facility caregiver, and may function as a top level physicians assistant focusing on administration of physicians assistants offering services at one or more assisted living facility, preferably serving at a regional administrative level, to ensure that physicians assistants at multiple assisted living facilities are addressing administrative issues consistently and to further ensure that the physicians assistants are focusing care and compliance with professional standards and industry norms.

“Physicians assistant student” is an individual currently studying to become a physicians assistant and may be a member of the medical center staff.

“Nurse” means a registered nurse, and may be a nurse with a particular specialty or title such as a director of nursing, wellness nurse, or wound-care nurse. The nurse is preferably a facility caregiver but may be a third party caregiver who administers nursing care to the residents. The nurse may also be employed by the medical center.

“Facility executive director” is a facility administrator who engages in day-to-day administration and management of the residential care facility.

“Dementia-care director” is preferably a facility caregiver but may be a third party caregiver who assists in the understanding and education of the community, facility staff, and family members in the association with elderly residents.

“Activities director” is preferably a facility caregiver but may be a third party caregiver who assists in organization of activities, games, programs, and outings for the elderly residents.

“Ombudsman” can be a facility caregiver, a third party caregiver and/or an individual associated with the state that assists residents and family members with complex insurance coverage and general grievances.

“Chaplain” is preferably a facility caregiver or a third party caregiver who assists in the spiritual needs of residents, family and community.

“Clinical pharmacist” is preferably a third party caregiver who works closely with prescribing professionals such as members of the medical center staff and the facility caregivers authorized to administer drugs in the proper dosing, administration, and tracking of drugs given to residents. The clinical pharmacist may be affiliated with a fulfillment pharmacy charged with medication oversight, on-site support, medication-medication interaction reporting, auditing, and pharmacy training.

“Gero-psychiatrist” is preferably a third party caregiver or facility caregiver who is available to meet with residents to address psychological, social, or other issues arising in the life of a resident. The gero-psychiatrist may prescribe medication.

“Physical therapist” is preferably a third party caregiver or facility caregiver who works with residents to restore motion, strength, functionality and ultimately independence to perform daily tasks in residents who need physical therapy services.

“Occupational therapist” is preferably a third party caregiver or facility caregiver who works with residents to restore motion, strength, functionality and ultimately independence to perform daily tasks in residents who need occupational therapy services.

“Speech Therapist” is preferably a third party caregiver or facility caregiver who works with residents to assess, diagnose, treat, and help to prevent speech, language, cognitive-communication, voice, swallowing, fluency, and other related disorders.

“Psychologist” is preferably a third party caregiver or facility caregiver who is available to meet with residents to address psychological, social, or other issues arising in the life of a resident.

“Licensed Clinical Social Worker” and “Nurse Case Managers” are preferably a third party caregiver or facility caregiver with a specialty in counseling, including grief, bereavement, family counseling, and adjustment, and knowledge and matchmaking with community resources.

“Podiatrist” is preferably a third party caregiver or facility caregiver with a specialty in podiatry, particularly useful to the treatment of some elderly residents.

“Respiratory therapist” is preferably a third party caregiver or facility caregiver with a specialty in respiratory therapy, particularly useful to the treatment of some elderly residents to provide respiratory care and enhance respiratory function.

“Dentist” is preferably a third party caregiver or facility caregiver with a specialty in dentistry, particularly useful to the treatment of some elderly residents.

“Ophthalmologist/optometrist” is preferably a third party caregiver or facility caregiver with a specialty in eye care, particularly useful to the treatment of some elderly residents.

“Medical technicians” are preferably facility caregivers and/or employed by the medical center, with the requisite licensures or certification to assist elderly residents in their specialty field.

“Care managers” are preferably facility caregivers and/or employed by the medical center, that serve as an additional liaison for the residents in their overall care. The care managers should be easily available to residents and should be resourceful and capable of fielding requests of the residents to the proper professional or entity.

“Third party payor” may be an insurance company, including a provider of healthcare insurance and/or long-term care insurance.

The invention is based on an improvement to the current method of assisted living organization and delivery of care whereby the delivery of assisted living care is medicalized. The invention includes a medical center at the residential care facility comprising medical center staff that administer a high level of medical care to residents. The medical center is preferably located within the residential care facility; for example, in an office or as a roving unit. The medical center may also be located close to the residential care facility preferably within walking distance or within one hundred yards of the facility. In one embodiment the medical center staff is comprised of one or more on-site physician medical director and one or more nurse practitioner and physician's assistant and optionally one or more rotating geriatric student such as a medical student, physicians assistant student, or nurse practitioner student, for administering a high level of medical care to the residents of the assisted living residential care facility. In another embodiment, the physician medical director serves as the administrative and community liaison for the facility. The medical center staff is integrated with a plurality of members of an interdisciplinary team, wherein the team comprises one or more facility caregiver and third party caregiver for administering care to residents. The facility caregiver and third party caregiver are from multiple disciplines. For example, a facility caregiver may be an executive director, corporate medical director, corporate physicians assistant, corporate nurse practitioner, nurse, director of nursing, wound care nurse, wellness nurse, physical therapist, respiratory therapist, dietician, dementia care director, activities director, ombudsman, chaplain, clinical pharmacist, gero-psychiatrist, psychologist, occupational therapist, speech therapist, licensed clinical social worker, ophthalmologist, podiatrist, dentist, medical assistant, or care manager. A third party caregiver may be a nurse, physical therapist, respiratory therapist, dietician, dementia care director, activities director, ombudsman, chaplain, clinical pharmacist, gero-psychiatrist, psychologist, podiatrist, dentist, occupational therapist, speech therapist, licensed clinical social worker, ophthalmologist, medical assistant, or care manager. The interdisciplinary team provides care and comes into contact with the residents that are also treated by the medical center staff.

Integration of the medical center staff with the interdisciplinary team means that the medical center staff is in communication with the interdisciplinary team regarding any care administered to a resident or contact made with a resident. Communication may be weekly or daily basis, or may occur after any care or contact is made with a resident. The integration of the medical center staff with the interdisciplinary team ensures that care of residents is comprehensive and cohesive, and is based upon the most up-to-date information about the resident; for example, information of high medical importance such as the type of medications prescribed to a resident or information concerning the resident's daily activities may be communicated to the medical center staff. The exchange of information concerning the residents is always in accordance with the law, especially in accordance with laws protecting the privacy of residents. The inventive geriatric assisted living care method, kit, and system, and the resulting integration of medical center staff with the interdisciplinary team also ensures infection control, quality assurance, safety of medical center staff and facility caregivers, up-to-date information on accidents and incidents, and decreases in medical errors.

Using the inventive geriatric assisted living care method, kit, or system, the physician or mid-level practitioner on-site patient encounter is now billed to Medicare (and/or other third party payor) utilizing a traditionally covered out-patient office visit code, rather than the poorly covered and poorly reimbursed house call or domiciliary codes utilized by traditional off-site practitioners heretofore.

The care delivery capabilities of the medical center extend to bringing in innovative healthcare, home care, mobile, and outpatient technologies on-site for diagnostics, therapeutics, screening, and wellness for facility employees, residents, and their families and friends (including, health fairs). For example, “CLIA Waived” finger stick lab tests (Glucose, Hemoglobin AIC, AST, ALT, Prothrombin Time/INR, CBC, Basic Metabolic Panel, and others), dipstick urinalysis testing, pulse oximetry (rest and exercise), nocturnal sleep oxygen saturation studies, electrocardiograms (EKG), Holter Monitor, spirometry testing, Bone Densitometry, Indirect Calorimetry are performed and read on-site. Innovative ultrasound technologies are not only routinely employed to look at organs like the heart, kidneys, liver/gall bladder, pancreas, bladder, and great vessels, but are also utilized to determine peripheral vessel and carotid vascular blood flow as well as non-invasive fluid balance determinations. Fluid-balance determinations include the determination of whether a resident is “wet” and over-hydrated or “dry” and under-hydrated. These additional determinations become additional “vital signs,” including: pulse oximetry, indirect calorimetry/Body Mass Index (BMI), and non-invasive ultrasound determinations of fluid status (including determinations of congestive heart failure). Accordingly, these additional vital sign determinations become more standardized and additionally serve to augment care at this level on-site, much like the pain assessment protocol on a scale of 1 to 10 has become recognized as the “5^{th} vital sign.” Other innovative technologies, including skin breakdown, fall and aspiration prevention and precautions, and incontinence devices, which likewise provide earlier detection of urinary tract infections, provide earlier warning, and provide enhanced detection for the facility and it's staff, giving residents and their families heightened safety, an improved quality of life, more awareness and assurance for high level of care while residing on-site. The facility reaps additional benefits from having employees and residents that are more apt to be monitored, educated, healthy, and health conscious, particularly as health savings accounts become more popular and incentives for healthy lifestyle approaches become fostered by businesses as well as third parties.

In one embodiment of the inventive geriatric assisted living care method, kit, and system, a whole new niche and level of care is created within the assisted living setting by bridging the gap between assisted living and nursing home/skilled nursing facility. Due to the “medicalization” of traditional assisted living facilities with the inventive geriatric assisted living care method, kit, and system, traditional long-term care insurance of healthcare insurance may now cover medically complex residents who may now continue to be housed and cared for on-site at a higher level of care.

In another embodiment, the services administered by the medical center staff are available 24 hours a day, 7 days a week by access to the medical center staff via in-person communication, communication via telephone, communication via pager, communication via voice mail, and communication via fax.

The medical center staff can also contribute to the education of the facility caregivers, third party caregivers, residents, family members of residents, and community by coordinating on-site health fairs, on-site lab testing stations, wellness lectures, vaccine promotion and implementation programs, and vaccine updates for residents, facility caregivers, and integrated third party caregivers.

The organization of the medical center staff as an educational service provider may also include the coordination of satellite assisted living and residential care clinical teaching sites, thereby extending geriatric, hospice and palliative care medical training and research. Such teaching sites may include affiliations with educational institutions such as universities and medical centers. Lectures can be provided on geriatric and aging topics; for example, the biology of aging, fall prevention and fractures, osteoporosis prevention, and proper hydration, physiology of aging, geriatric sexuality, principles of geriatrics and gerontology, physical rehabilitation, geriatric syndromes, neuropsychiatry, aging and the various organ systems, immobility, failure to thrive and frailty, psychotropic medication management, urinary tract infections, agitation and psychosis, antibiotics, unexplained weight loss, proper diets, diabetes mellitus management, role of exercise, pressure ulcers, skin and wound care, stress reduction, obesity, wellness and healthcare maintenance and screening, emergency responses including “911” responses, management of diarrhea and constipation, sleep-related breathing disorders and insomnia, resident's rights, dementia, delirium, depression, pain management, cardiac medications, gastrointestinal medications, role of hospice and palliative medicine and end-of-life care, role of vaccination programs, infection control measures, and signs of elder abuse.

The medical center staff can also coordinate and ensure certification and recertification by offering programs to facility caregivers, scheduling programs, or notifying caregivers of relevant programs. For example, care managers may be offered, scheduled for, or notified of a program to be certified or recertified to administer medication, manage incontinence, or detect urinary tract infections.

The medical center staff further assists in the creation of procedures and protocols including, but not limited to procedures and protocols for treating residents, and maintaining, storing, creating and retrieving records regarding residents. Such procedures and protocols can be stored electronically or on paper. The medical center staff further assists in tracking certification and licensing requirements and whether such requirements are met by the individuals in the medical center staff and any members of the interdisciplinary team that are employed by the facility or who have engaged with the facility as an independent contractor. The organization of medical center staff for the administration of a broad level of medical care to residents may also provide for a cost-efficient method of treatment for residents wherein long-term care insurance or other healthcare insurance coverage and/or medical tax breaks are now available for payment of all or a portion of the medical care administered by the medical center staff.

In one embodiment of the inventive method of the delivery of care, the medical center staff, including the physician medical director and mid-level practitioner, such as a nurse practitioner and/or physician's assistant, lead interdisciplinary on-site teams. For example, this team leader model:
1. Provides medical decision input and support to one or more of the following individuals such as the facility executive director, the wellness nurse director, the dementia director, the corporate medical director, the corporate physicians assistant, the corporate nurse practitioner, and the governing body of the facility;
2. Provides leadership of a clinical interdisciplinary team on a weekly basis and administrative team meetings on a monthly basis with facility caregivers;
3. Implements resident care policies and procedures;
4. Coordinates medical care and treatment, including policies and directives regarding attending physicians;
5. Assists in developing systems so that all necessary medical services provided to residents are adequate and appropriate;
6. Consults regarding the facility's quality assurance process for the assurance of quality medical and medically-related care;
7. Advises the facility administration including the facility executive director, the corporate medical director, the corporate physicians assistant, the corporate nurse practitioner, and the facility governing body of current medical issues affecting residents of the community;
8. Provides 24 hour per day “on-call” availability and medical response to urgent or emergent facility needs;
9. Participates in the development and presentation of educational programs and health fairs for residents, families, and the public (including training and re-training modules for staff);
10. Participates in employee health, welfare, and safety of employees (including on-site wellness physicals, Purified Protein Derivative (PPD) testing, and vaccination programs);
11. Helps articulate the facility's mission to the community and represent the facility in the community;
12. Provides medical leadership for geriatric research and development, clinical training, preventive medicine (including wellness principles), and medical information in the assisted living setting;
13. Participates in establishing policies and procedures for assuring that the rights of individual residents are respected and enhanced (including reducing physical and chemical restraints);
14. Reviews the medication administration record (MAR) of residents in the community and participates in quarterly meetings with the clinical pharmacist, a pharmacy liaison from the fulfillment pharmacy group;
15. Provides admission or updated Mini Mental Status (MMSE) Testing, Geriatric Depression Screening, Geriatric Suicidal Ideation Inventory, Acquired Involuntary Movement System (AIMS) Testing, and admission or annual Residential Care Facility Forms (RCFE's) as needed; and
16. Provides on-site Health Insurance Portability and Accountability Act (HIPAA) and Occupational Safety and Health Administration (OSHA) compliance manuals and officers.

With the medical center staff serving as an educational hub by extending geriatric on-site training to physician's assistant students, nurse practitioner students, medical students, and facility caregivers, a campus-like atmosphere is created which fosters additional social networking through computer/internet involvement, resident participation in local college courses, and promotion of social activities and enhanced community and support-group building. This assists in the overall care of the residents as it provides for exposure and interaction with the greater community, in contrast to the often isolating setting of an assisted living facility. Residents are less isolated and are stimulated by the positive interaction with others.

In another embodiment, the method of delivering care includes the administration of care by the medical center staff to facility caregivers. The administration of care to facility caregivers may include, but is not limited, to conducting employee physicals, administering vaccines, and addressing work injuries. The overall care of residents is thus enhanced as the health of their caregivers is monitored and improved.

The invention may also include a kit for organizing comprehensive care to residents of an assisted living facility that includes an organizational chart of the staff of a medical center located within or affiliated with the residential care facility. The medical center may be on-site or in close proximity to the residential care facility. Preferably, the medical center is on-site. The medical center staff may include a physician medical director and one or more physician's assistant or nurse practitioner. The medical center staff may also include one or more medical student, physicians assistant student, or nurse practitioner student. The medical center staff may further include a medical assistant. The kit may also include an organizational chart detailing the relationship of the medical center staff with an interdisciplinary team of facility caregivers and third party caregivers. The relationship is one where the medical center staff is in communication with the interdisciplinary team of facility caregivers and third party caregivers such that they are all integrated and working together in the delivery of care. Two or more written procedures for directing the medical care offered by the medical center are also included. For example, the written procedures may include a procedure for the first time the medical center staff examines a resident, a procedure for subsequent examinations, a procedure for general management of the medical center, and a procedure for scheduling appointments. A sample procedure for scheduling appointments is one that has six steps comprising:
1. Nurse, such as a wellness nurse, keeps appointment book to make appointments when doctor is not at facility.
2. New patients are all scheduled for one-hour appointments.
3. Nurse distributes new patient packets to patients and/or family members who need a physician.
4. Returning patients are scheduled for 30 minutes.
5. Employee physicals are scheduled for 30 minutes.
6. When office hours are in session, the medical assistant will make follow-up appointments.

Another sample procedure may outline the duties of a medical assistant:
1. Get mail out of mail box.
2. Get appointment book from nurse, such as a wellness nurse, and make sure all patient medication lists are given to you for the patient's being seen that day (the wellness nurse does this for you—if not you may photocopy them yourself); staple the medication lists and put in prescription section of patient's chart.
3. Make copy from appointment book and distribute to relevant on-site medical staff.
4. Pull charts for patient's being seen that day.
5. Attach a “superbill” template to the front of the patient's chart and put the patient's name and date on the bill.
6. Place a “progress note” template in the progress note section in the chart and put each patient's name and date on it unless they are a **NEW patient, in this use the “complete progress note” template (three pages).
7. On the backside of progress note divider, write “see medication list” and today's date.
8. Open mail and put on desk for review by the physician's assistant or nurse practitioner and the physician medical director.
9. Get all necessary paperwork ready in chart depending upon reason for visit (i.e. lab work, x-rays, hospital notes, consultation referral notes and/or other relevant templates).
10. Make copies when needed for file folders and for the nurse practitioner, the physician's assistant, and/or the physician medical director.

The kit may also include one or more written procedure for hosting health fairs or wellness lectures. These fairs promote the transmission of health information to residents. The kit may further include one or more written procedures for hosting lab technicians at the residential care facility. Such visits offer an easy way for residents to receive lab work. The kit may further include one or more written procedure for hosting vaccine implementation programs. These programs aid in the direct promotion of vaccine education and timely administration. The kit may also include one or more written procedure for coordinating satellite assisted living facility clinical teaching sites. The kit may further include one or more written procedure for tracking certification and licensure of the medical center staff and the facility caregivers. The kit may also include one or more written procedure for administering care to facility caregivers, including but not limited to conducting employee physicals, administering vaccines, and addressing work injuries.

The invention may also include a system for organizing care provided to residents of an assisted living facility comprising the ability to store personal and medical data pertaining to a resident, the ability of the medical center staff to access and update the data, and the ability of the facility caregivers and third party caregivers to access the data, wherein the data of the resident is the most up-to-date data available and access by the medical center staff, facility caregiver, or third party caregiver allows it to offer care based upon this comprehensive set of up-to-date information. Accessibility of information is in accordance with applicable laws such that the privacy of the resident is lawfully maintained. The information is also stored and transmitted in accordance with HIPAA. Storage and access of the data may be via a computer system. Access may be via a computer on a computer network. Storage may be via a server. The server is capable of receiving information from each of the medical center staff, facility caregiver, and third party caregiver; for example, information regarding incidents related to health and safety of the residents, whereby the server receives, transmits, and retains information input. The medical center staff and authorized facility caregivers and third party caregivers can then access the information to facilitate the administration of care, and the monitoring, and management of the facility and residents. Employee Health and Safety including accidents and incidents are likewise overseen, monitored, and tracked. The system may further include proprietary geriatric templates, including, but not limited to, progress notes, comprehensive wellness exams, geriatric depression screening, MMSE's, and AIMS Testing. These templates provide a standardized mechanism for the input of care information. The standardization of information provides for more efficient care whereby information is easy to read, input, and extract.

The system may include the ability of the medical center staff to track certification and licensure of the medical center staff and the facility caregivers. The system may also include the ability of the medical center staff to offer educational programs to one or more third party assisted living facility.

Implementation of the inventive, method, kit, and/or system provides treatment of aging residents on-site at a higher level of care in the assisted living setting throughout the continuum of their lives, even when the spectrum of inevitable progressive functional and/or cognitive decline occurs with aging with the concomitant loss of key instrumental activities of daily (“IADL's”) and activities of daily living (“ADL's”). While residing within the assisted living or residential care facility implementing the inventive method, kit, and/or system, aging residents who develop resultant medical complexity, functional decline, progressive dementia, and life-limiting illness (requiring palliative or end-of-life care), can continue to be well cared for on-site. Moreover, as a byproduct of the inventive enhanced on-site assisted living and residential care, with earlier, timely interventions becoming the “norm,” costly and disruptive transfers to emergency rooms and acute hospitalizations can also be avoided.

Third party payors, who heretofore have been “carved out” of the assisted living arena, may now participate in this new inventive paradigm of enhanced geriatric assisted living care through the extension of long-term care policies, healthcare coverage, and/or medical tax breaks for residents in a medically augmented assisted living environment. Geriatric training is likewise extended and enhanced utilizing the inventive geriatric assisted living method, kit, and/or system, wherein the medical center is an educational hub facilitating training of the next generation of geriatric primary care physicians, physicians assistants, nurse practitioners, and nursing students. This training according to one embodiment of the invention advantageously serves to develop professional expertise in an area projected to have a significant shortfall of capable professionals.

The aforementioned embodiments further provide more cost-efficient, streamlined and integrated care at an assisted living residential care facility level. The methods, kit, and system provide for higher acuity care for medically complex facility residents. Implementation of the methods, kit, and system allow for residents to stay at the facility, lessening transfer to other skilled nursing facilities, nursing homes, or hospitals; thereby achieving a better outcome of care, decreased disorientation, and decreased medication error.

Implementation of the methods, kit and system may also decrease risk associated with running a facility, allowing aging residents to remain on-site as they are cared for throughout the continuum of their care, which now may include inevitable medical complexity, progressive dementia, and life-limiting illness requiring hospice and palliative care.

While the description above refers to particular embodiments of the present invention, it should be readily apparent to people of ordinary skill in the art that a number of modifications may be made without departing from the spirit thereof. The presently disclosed embodiments are, therefore, to be considered in all respects as illustrative and not restrictive.

### BRIEF DESCRIPTION OF THE FIGURES

FIG. 1 is chart showing the organization and integration of the medical center staff with the facility caregiver and the third party caregiver in accordance with an embodiment of the present invention.

FIG. 2 is a chart showing storage of medical and personal data and templates, and the ability to access and update the data and templates by various individuals in accordance with an embodiment of the present invention.

FIG. 3 is a chart of a sample kit in accordance with an embodiment of the present invention.

### DETAILED DESCRIPTION OF THE DRAWINGS

The invention is a method, system, and kit for the delivery and administration of cohesive and comprehensive care to residents of an assisted living facility.

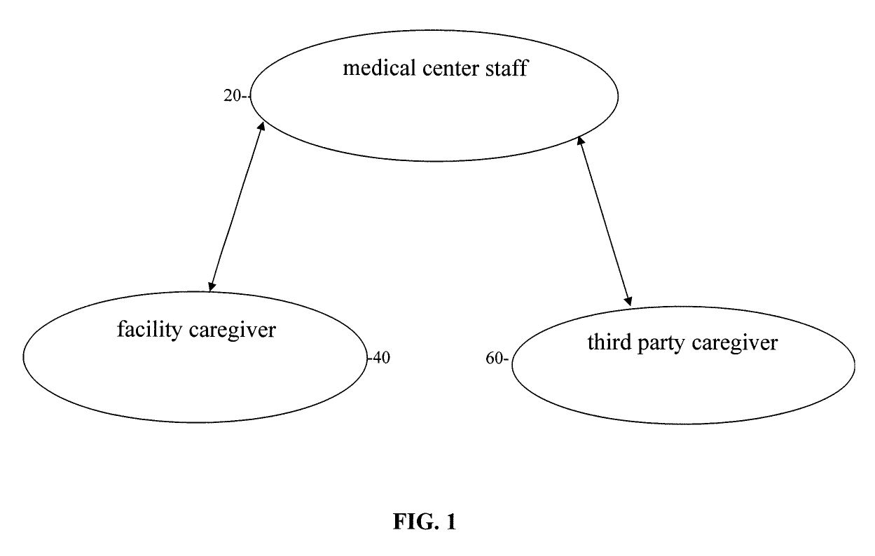

In one embodiment, as depicted in FIG. 1, the medical center staff 20 is intimately connected with a facility caregiver 40 and an integrated third party caregiver 60. The medical center staff 20 serves as the center of an resident's care meaning that it is in contact with one or more facility caregiver 40 and third party caregiver 60 to ensure that the delivery of care to a resident is streamlined, comprehensive, and cohesive. Organizing the medical center staff 20 as the hub of care serves to deliver the most comprehensive and cohesive care to a resident.

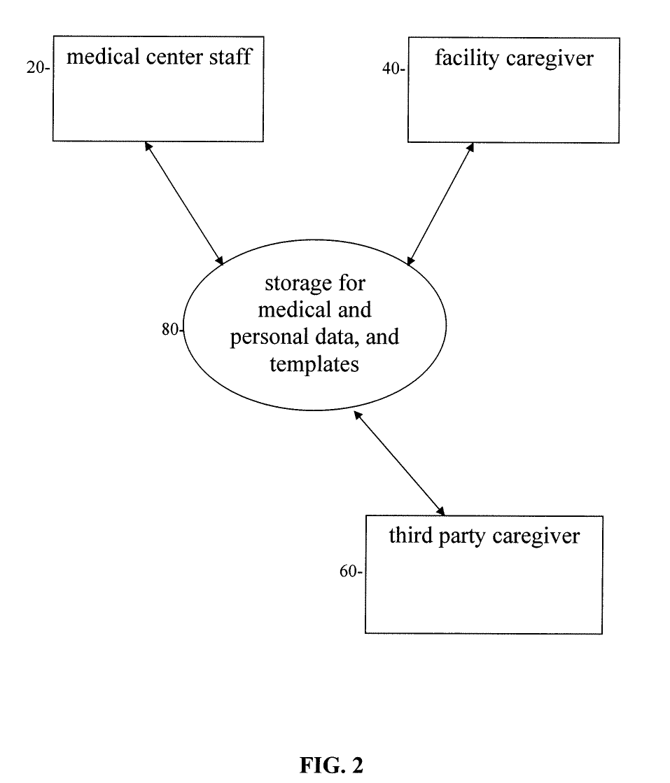

As depicted in FIG. 2, the medical and personal data is stored in a central location 80, preferably on a server. Geriatric templates may also be stored in a central location 80, preferably on a server. The data 80 is accessible and updateable by the medical center staff 20, the facility caregivers 40, and the third party caregivers 60.

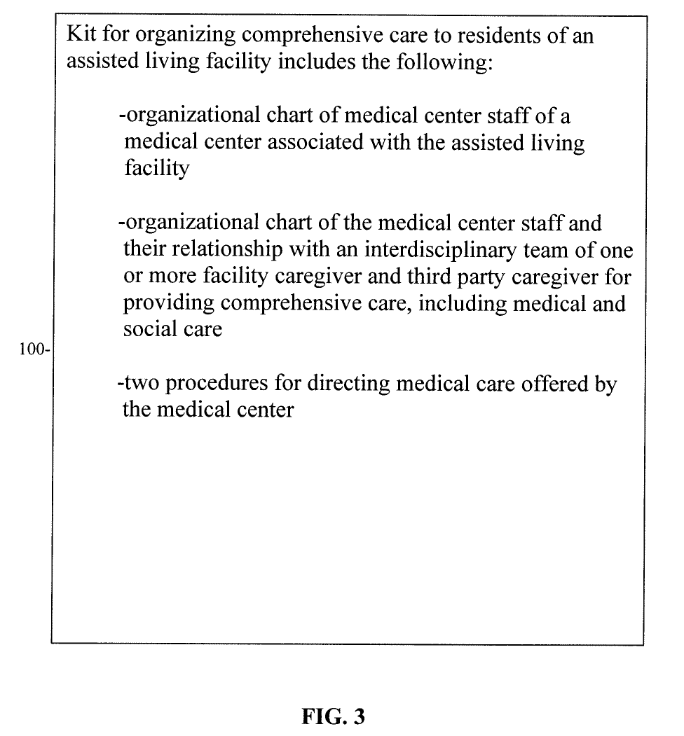

As depicted in FIG. 3, one embodiment of a kit 100 of the present invention is shown containing an organizational chart of the medical center staff of a medical center associated with the assisted living facility, and preferably located within the facility for providing medical care to residents, an organizational chart of the medical center staff and their integration with an interdisciplinary team of one or more facility caregiver and third party caregiver for providing comprehensive care, including medical and social care to residents, and two procedures for directing medical care offered by the medical center.

What is claimed:

1. A method of delivering care to residents of an assisted living facility, comprising:
providing a medical center at the assisted living facility for the medical treatment of residents,
staffing the medical center with medical center staff comprising one or more physician medical director, nurse practitioner, or physicians assistant for the administration of medical care to the residents, and
integrating the medical center staff with an interdisciplinary team comprising one or more facility caregiver and third party caregiver for the administration of care not provided by the medical center staff.

2. The method of claim 1, wherein the physician medical director is an administrative and community liaison for the facility.

3. The method of claim 1, wherein the medical center staff further comprises one or more medical student, physicians assistant student, or nurse practitioner student.

4. The method of claim 1, wherein the facility caregiver comprises an individual selected from the group consisting of a facility executive director, corporate medical director, corporate physicians assistant, corporate nurse practitioner, nurse, physical therapist, respiratory therapist, dietician, dementia care director, activities director, ombudsman, chaplain, clinical pharmacist, gero-psychiatrist, occupational therapist, speech therapist, ophthalmologist, licensed social worker, psychologist, podiatrist, dentist, medical assistant, care manager, or medical technician.

5. The method of claim 1, wherein third party caregiver comprises an individual selected from the group consisting of a nurse, physical therapist, respiratory therapist, dietician, dementia care director, activities director, ombudsman, chaplain, clinical pharmacist, gero-psychiatrist, occupational therapist, speech therapist, ophthalmologist, licensed social worker, psychologist, podiatrist, dentist, medical assistant, care manager, or medical technician.

6. The method of claim 1, wherein integration of the medical center staff with the interdisciplinary team comprises conducting a weekly meeting with the interdisciplinary team.

7. The method of claim 1, wherein integration of the medical center staff with the interdisciplinary team comprises conducting a daily meeting with the interdisciplinary team.

8. The method of claim 1, wherein the administration of care by the medical center staff is covered by a third party payor.

9. The method of claim 1, wherein integration of the on-site medical staff with the interdisciplinary team comprises providing communication access to the medical center staff twenty-four hours a day, seven days a week.

10. The method of claim 9, wherein communication access comprises communication in-person, communication via telephone, communication via pager, communication via voicemail, or communication via fax.

11. A kit for organizing comprehensive care to residents of an assisted living facility, comprising:
an organizational chart of medical center staff of a medical center located at the assisted living facility for providing medical care to residents,
an organizational chart of the medical center staff and their relationship with an interdisciplinary team of one or more facility caregiver and third party caregiver for providing medical and social care to residents, and
two or more written procedures for directing the medical care offered by the medical center,
wherein the organizational chart of the medical center staff and their relationship with an interdisciplinary team shows the medical center staff as a central hub with each member of the interdisciplinary team reporting to the medical center staff concerning the residents.

12. The kit of claim 11, further comprising one or more written procedure for hosting health fairs or wellness lectures for promotion of health information to residents.

13. The kit of claim 11, further comprising one or more written procedure for hosting lab technicians for ease of obtaining lab work for residents.

14. The kit of claim 11, further comprising one or more written procedure for hosting vaccine promotion and implementation programs.

15. The kit of claim 11, further comprising one or more written procedure for coordinating satellite assisted living facility clinical teaching sites.

16. The kit of claim 11, further comprising one or more written procedure for tracking certification and licensure of the medical center staff and the facility caregivers.

17. A system for organizing care provided to residents of an assisted living facility, comprising:
means for storing personal and medical data pertaining to a resident,
means for a medical center staff member, facility caregiver and third party caregiver to access the data pertaining to the resident, and
means for the medical center staff member, facility caregiver, and third party caregiver to update the data pertaining to a resident, wherein the information is accessible and updateable twenty-four hours a day, seven days a week to ensure care of the resident is in accordance with the most up to date data available.

18. The system of claim 17, wherein the means for storing data further comprises storing geriatric templates.

19. The system of claim 17, further comprising a means for the medical center staff to track certification and licensure of the medical center staff and the facility caregivers.

20. The system of claim 17, further comprising means for the medical center staff to offer educational programs to one or more third party assisted living facility.
